(19) United States
(12) Patent Application Publication
(10) Pub. No.: US 2026/0337118 A1
(43) Pub. Date: Oct. 29, 2026

(54) Thermal Vascular Self-Responsive Composites for Civil Infrastructure

(71) Applicant: Drexel University, Philadelphia, PA (US)

(72) Inventor: Yaghoob Farnam, Philadelphia, PA (US)

(21) Appl. No.: 19/099,812

(22) PCT Filed: Aug. 21, 2023
(86) PCT No.: PCT/US2023/030684

§ 371 Date: Jan. 30, 2025

Related U.S. Application Data
(60) Provisional application No. 63/399,742, filed on Aug. 22, 2022.
(60) Provisional application No. 63/464,959, filed on May 9, 2023.

(51) Int. Cl. C04B 38/04; C04B 103/00

(52) U.S. Cl. CPC C04B 38/04; C04B 2103/0071

(57) ABSTRACT

Vascularization in nature creates a constituent system that enhances thermal exchange between components and autonomously responds to different environmental stimuli, such as moisture and temperature, to create equilibrium for organisms. Infrastructure designed with traditional design methods often encounters degradation over their lifespan without featuring autonomous responses to chemical/mechanical deterioration imposed by harsh environments. Vascular architectures can be engineered for further application in construction materials to provide necessary mass/heat transport for thermo-regulation in infrastructure. This concept is investigated using a phase change material (PCM) liquid injected into various architected vascular networks. The invention provides vascular networks using sacrificial components at multi-length scales and integrates PCM thermal self-responsive functionality in cementitious composites.

### BACKGROUND OF THE INVENTION

### Field of the Invention

The invention relates to a system for thermal control of civil infrastructure using phase-change materials.

### Description of the Related Art

Since 1970, CO₂ emissions have increased by approximately 90% with fossil fuel combustion and industrial developments contributing to 78% of the total greenhouse gas emission rise. The built environment is responsible for approximately 40% of global energy consumption and 33% of greenhouse gas emissions. Due to the rising costs of fossil fuels and depleting sources of natural reserves, alternative solutions have become imperative for the thermoregulation of buildings and commercial spaces.

It would be beneficial to provide a passive thermoregulation system for civil infrastructure to reduce heating/cooling energy usage and cost.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Civil infrastructure is exposed to variety of dynamic stimuli like biological cases such as thermal, moisture, mechanical, and light loadings; and nature-inspired VASCular concepts can be used to create next-generation Infrastructure materials, (“VASCI”). VASCI can autonomously respond to accommodate environmental conditions and service-life needs for better performance and/or multi-functionalities.

Here we provide passive self-thermal responsive functionality to engineer thermal-VASCI that can be used in civil infrastructure for thermoregulation and thermal energy management strategies. Thermal-VASCI can be used to create infrastructure components (such as panels, prefabricated elements, tiles, walls, floors, and ceiling) and then used in: buildings for thermoregulation (for lowering energy demands in buildings which are responsible for ~40% of the world's energy usage), infrastructure snow-melting/deicing applications, or infrastructure exposed to thermal loading to reduce thermal cracking.

To engineer thermal-VASCI, the present invention provides methods to create vascular channels at multi-scale lengths in cementitious materials to create VASCI and (2) incorporate passive thermal self-responsive phase change materials (PCM) fluid in cementitious matrix.

In one embodiment, the present invention is a method of forming a thermal vascular self-responsive composite comprising the steps of: providing a cementitious composite material; inserting a sacrificial architected vascular object into the material; dissolving the sacrificial object, forming a channel; and inserting a phase change material into the channel. Melting or evaporation techniques can be used to remove the sacrificial object in addition to dissolution technique depending on the type of the sacrificial materials.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is a graph showing dissolution rates of sacrificial filaments in different solutions;

FIG. 2 is a graph showing weight Change (%) of P400SR filament in pore solution vs deionized (D.I.) water;

FIG. 3 is a test set-up used to incorporate a single mono channel defect into a test sample;

FIG. 4A is a top plan view of an outlet model according to the present invention;

FIG. 4B is a side view of the outlet model of FIG. 4A;

FIG. 5A is a top plan view of a single vertical channel architecture;

FIG. 5B is a top plan view of triple parallel channel architecture;

FIG. 5C is a top plan view of a single diagonal channel architecture;

FIG. 5D is a top plan view of a triple diagonal channel architecture;

FIG. 6A is a top plan view of a diamond pattern architecture;

FIG. 6B is a top plan view of the diamond pattern architecture of FIG. 6A, showing the location of outlets on the diamond architecture;

FIG. 7A is a perspective view of a reference specimen;

FIG. 7B is perspective view of a single channel specimen;

FIG. 7C is a perspective view of a triple channel specimen;

FIG. 8A is a top plan view of an X ray tomography of a diamond architecture;

FIG. 8B is a side elevational view of the X ray tomography of FIG. 8A;

FIG. 8C is a sectional view of the X ray tomography of FIG. 8A;

FIG. 9A is a top plan view of an X ray tomography of a single channel architecture;

FIG. 9B is a side elevational view of the X ray tomography of FIG. 9A;

FIG. 9C is a sectional view of the X ray tomography of FIG. 9A;

FIG. 10A is top plan view of a channel formed after partial filament dissolution;

FIG. 10B is a top plan view of a channel formed after total filament dissolution;

FIG. 10C is an end elevational view of the channel of FIG. 10B;

FIG. 11 is a graph showing average tensile strength for various architectures;

FIG. 12A is a perspective view of a control specimen fracture patter;

FIG. 12B is front elevational view of the control specimen fracture pattern of the specimen of FIG. 12A;

FIG. 13A is a side elevational view of a fracture pattern of a straight channel broken in a parallel direction, with end views of the broken pieces;

FIG. 13B is a side elevational view of a fracture pattern of a straight channel broken in a perpendicular direction, with end views of the broken pieces;

FIG. 13C is a side elevational view of a fracture pattern of a diagonal channel broken in the parallel direction, with end views of the broken pieces;

FIG. 14A is a top plan view of a tri-channel fracture pattern of straight channels broken in the parallel direction, with end views of the broken pieces;

FIG. 14B is a top plan view of a tri-channel fracture pattern of straight channels broken in the perpendicular direction, with end views of the broken pieces;

FIG. 15 is a top plan view of a multi diamond fracture pattern, with end views of the broken pieces;

FIG. 16 is a graph showing a temporal plot of reference, 1-Channel, and 3-Channel Vascular Self-Responsive Composites for Civil Infrastructure (“VASCI”) specimens;

FIG. 17A is an infrared image of Reference VASCI specimen with ROIS;

FIG. 17B is a regions of interest (“ROIs”) temporal plot of the Reference VASCI specimen of FIG. 17A;

FIG. 17C is an infrared image of a 1-Channel specimen with ROIs;

FIG. 17D is a ROIs temporal plot of the 1-Channel VASCI specimen of FIG. 17C;

FIG. 17E is an infrared image of a 3-Channel VASCI specimen with ROIs;

FIG. 17F is a ROIs temporal plot of the 3-Channel VASCI specimen of FIG. 17E;

FIG. 18A is a temperature profile of the infrared thermograph investigation of Reference, 1-Channel, and 3-Channel VASCI specimens;

FIG. 18B is a histogram plot at region [I] of FIG. 18A;

FIG. 18C is a histogram plot at region [II] of FIG. 18A;

FIG. 18D is a histogram plot at region [III] of FIG. 18A;

FIG. 18E is a histogram plot at region [IV] of FIG. 18A;

FIG. 19A is a thermal contour profiles of a Reference specimen;

FIG. 19B is a thermal contour profiles of a 1-Channel VASCI specimen; and

FIG. 19C is a thermal contour profiles of a 3-channel VASCI specimen.

### DETAILED DESCRIPTION

In the drawings, like numerals indicate like elements throughout. Certain terminology is used herein for convenience only and is not to be taken as a limitation on the present invention. The terminology includes the words specifically mentioned, derivatives thereof and words of similar import. The embodiments illustrated below are not intended to be exhaustive or to limit the invention to the precise form disclosed. These embodiments are chosen and described to best explain the principle of the invention and its application and practical use and to enable others skilled in the art to best utilize the invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

The word “about” is used herein to include a value of +/−10 percent of the numerical value modified by the word “about” and the word “generally” is used herein to mean “without regard to particulars or exceptions.”

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Unless explicitly stated otherwise, each numerical value and range should be interpreted as being approximate as if the word “about” or “approximately” preceded the value of the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Latent thermal energy storage systems incorporate Phase Change Materials (PCM), which are substances that release or absorb sufficient energy at phase changes to provide heating or cooling. For example, during the liquid-solid phase transition, as the PCM solidifies, latent heat is released. Similarly, for solid-liquid transitions, the latent heat is absorbed. The particular advantage of utilizing PCMs is the capacity to store heat at a relatively constant temperature during phase transitions, as well as the volumetric quantity of heat storage that PCMs provide, as compared to other alternatives such as sensible heat storage units. PCM incorporation can help buildings maintain their internal temperatures despite weather fluctuations which lowers energy costs and improves thermal efficiency. The passive fluid will naturally store available solar energy in the day and expel it during the nighttime.

Two main types of PCMs are utilized in thermal energy storage systems: salt-based and paraffin-based. Salt-based PCMs are inorganic compounds with high latent heat values, but present issues such as subcooling, corrosiveness to metals and phase separation which make them unappealing to large scale projects. As a result, paraffin based PCMs have been investigated to provide more promising results due to their non-corrosive and low subcooling properties, chemical stabilities, and dependable cycling. Their main undesirable properties include flammability and lower thermal conductivities, which can result in lower overall system efficiency.

A exemplary method utilized to improve the paraffin PCMs faults is by increasing the surface area for heat transfer by utilizing a vascularized system and embedding the PCM in the vascular channels into a fire-resistant matrix of material, such as, by way of example only, concrete. This optimized geometric pattern allows for the PCM to be efficiently and uniformly spread through the composite material. The process of injecting the PCM in the channel voids additionally assists with enhancing the thermal and mechanical stability of the concrete. Additionally, the vascular channel will allow replacing the type of PCM in thermal-VASCI when the environmental temperature changes by withdrawing and injecting method; this improves the thermal response of thermal-VASCI throughout all seasons of the year.

Thermal energy storage (TES) is a cost-effective form of energy storage that can reduce peak energy consumption demands and the overall carbon footprint. This storage system is ideal for heating and cooling redistribution applications and electrical energy generation. Stored heat energy in TES units can shift the peak load demand to off peak hours due to a material absorbing energy with rising temperature and losing energy with decreasing temperature. By taking advantage of this characteristic, materials can achieve different thermal properties. These systems can reduce peak energy consumption by storing energy when there is less demand and expelling that stored energy when demand increases.

### Materials and Methods

### Materials

Paraffin-based PCM18, with a melting/freezing point at approximately 18 °C, was utilized as its application in HVAC systems can reduce energy costs in buildings when outside temperatures are at approximately 18 °C±~5 °C. Table 1 reports the thermal properties of concrete and paraffin-based PCM18 utilized in these experiments.

TABLE 1
Material Properties of concrete and paraffin based PCM 18

| | k (W m⁻¹ K⁻¹) | ρ (kg m⁻³) | Cₚ (kJ kg⁻¹ K⁻¹) |
|---|---|---|---|
| Concrete | 2 +/− 0.8 | 2200 +/− 200 | 0.85 +/− 0.15 |
| Liquid Paraffin | 0.2 +/− 0.7 | 766 +/− 340 | 2981 +/− 190 |
| Solid Paraffin | 0.2 +/− 0.7 | 865 +/− 148 | 2604 +/− 248 |

Type I cement powder was prepared as a paste by using a rotary vacuum mixer. Polystyrene square petri dishes (100 mm×100 m×10 mm) were provided.

A P400SR polymer filament (1.75 mm diameter), a neutral pH adhesive (Acid-free, PVA Formula, Water soluble), sodium hydroxide, and potassium hydroxide were all provided. Those skilled in the art will recognize that any polymer that can be removed in a hydroxide solution, such as sodium hydroxide (NaOH), potassium hydroxide (KOH), calcium hydroxide (Ca(OH)₂), or other suitable hydroxide, can be used. The polymer can be removed by dissolution, evaporation, melting, or other known or unknown method.

TABLE 2
Chemical composition, Bogue composition, and relevant properties of
Type I Ordinary Portland Cement (“OPC”) used in this study.

| | Percentage | | |
|---|---|---|---|
| | by mass | | |
| Item | (%) | Properties | Values |
| Silicon Dioxide (SiO₂) | 19.22 | Air Content (%) | 9.93 |
| Aluminum Oxide | 5.92 | Blaine (m²/kg) | 400.5 |
| (Al₂O₃) | | | |
| Ferric Oxide (Fe₂O₃) | 2.73 | % Pass 325 Mesh | 96.62 |
| Calcium Oxide (CaO) | 62.59 | 14-day C 1038 | 0.006 |
| | | Expansion % | |
| Magnesium Oxide | 2.76 | % Autoclave | 0.09 |
| (MgO) | | Expansion | |
| Loss on Ignition (LOI) | 2.70 | | |
| Sulfur Trioxide (SO₃) | 4.15 | Compressive Strength | |
| Sodium Oxide (Na₂O) | 0.34 | 1-Day (psi) | 2872 |
| Potassium Oxide (K₂O) | 1.04 | 3-Day (psi) | 4033 |
| Total Alkali | 1.02 | 7-Day (psi) | 4620 |
| Insoluble Residue | 0.24 | 28-Day (psi) | 5613 |
| Limestone | <=5.0 | | |
| L color | 59.14 | Time of Set (minutes) | |
| C₃S (Bogue) | 53.30 | Initial | 117 |
| C₂S (Bogue) | 14.90 | | |
| C₃A (Bogue) | 11.10 | | |
| C₄AF (Bogue) | 8.30 | | |

TABLE 3
Experimental program for this study

| | Specimen | Specimen Curing Conditions |
|---|---|---|
| Test | Dimensions | and Testing Parameter |
| Direct Tensile | 100 × 100 × | 14 days - room temp (~25 °C) |
| Test | 10 mm³ | 2 mm/min extension |
| | | 5 kN load cell |
| Infrared | 100 × 100 × | |
| Thermography Test | 10 mm³ | |

### Dissolution Test

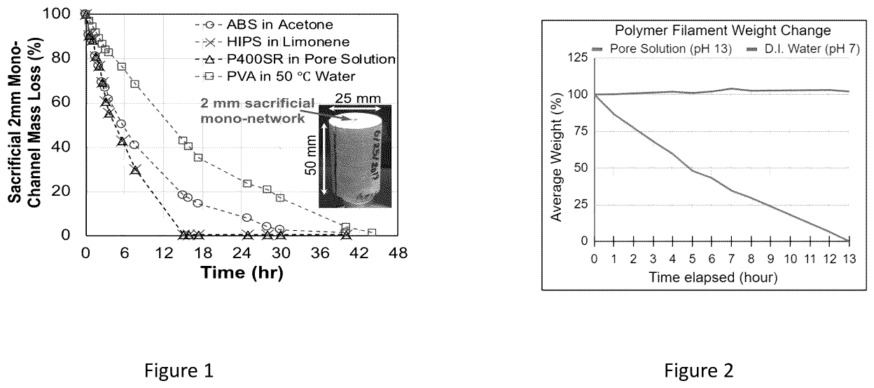

Preliminary studies were conducted to test the dissolution rate of different 2 mm sacrificial materials in different solutions. FIG. 1 shows dissolution rates of sacrificial filaments in different solutions. The use of P400SR filament in a synthesized pore solution, which is a high alkaline solution (e.g. NaOH, KOH, Ca(OH)₂) available in cementitious material pores, showed to be the most effective material as it had the shortest dissolution time. The advantage of using pore solution as a solvent is the compatibility with concrete and the resistance of altering the chemical makeup of the concrete. P400SR filament was used to create a sacrificial architected vascular object that is removed using dissolution technique. Melting or evaporation techniques can be also used to remove the sacrificial object in addition to dissolution technique depending on the type of the sacrificial materials. For example, paraffin wax or styrofoam based materials can be used to create the sacrificial object that can be removed using either melting or evaporation techniques.

Additional tests were done in order to understand the dissolution of the filament in comparison to de-ionized (“D.I.”) water. A P400SR filament was cut into ten 1-inch segments and the mass of each individual piece was recorded. Five 1-inch segments of P400SR filament were placed in a 20 mL test tube containing D.I water (pH=7) and five 1-inch segments were placed in a 20 mL test tube containing pore solution (pH=13), 250 mL D.I. Water+3 g NaOH+7.29 g KOH). At one-hour intervals, each segment was removed, dried, and weighed. See FIG. 2, The weight Change (%) of P400SR filament in pore solution vs D.I. water demonstrates the weight change (%) of the ten filament segments over a 13-hour period and thus measures the impact of submerging the sacrificial filament in a pore solution on dissolution rates and provides a timeframe of dissolution for future experiments.

The preparation of the square concrete slabs (100 mm×100 mm×10 mm, water-to-cement ratio: 0.42) was performed in a rotary vacuum mixer at 300 revolutions per minute for 60 seconds, hand mixed for ≈10 seconds, then mixed under vacuum conditions for an additional 60 seconds. The first step was to generate control samples to serve as a baseline for the experiment.

In order to form vascularization of cementitious composites, sacrificial filaments were inserted in cementitious mixtures and removed by method of dissolution. Initial concerns rose with this concept specifically in comparison to other materials due to concretes' porous nature, the concrete's curing process, and the chemical and physical stability of the specimen after dissolution. Vascular channels had to be implemented in cementitious mixtures without majorly altering the chemical makeup or mechanical stability of the concrete.

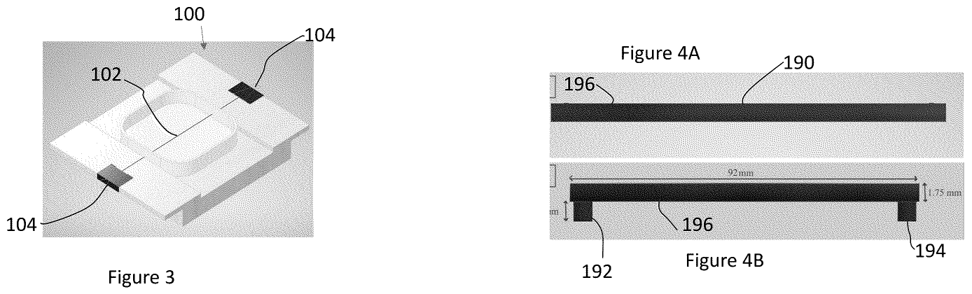

Two methods were taken to incorporate a single mono channel (≈92 mm) defect into the sample: (1) Binder Clip method, shown in FIGS. 3 and (2) Outlet method, shown in FIGS. 4A-4B. The Binder Clip method was the initial test that was run in order to incorporate the filaments in the middle of a concrete slabs, without extraneous movement during the pouring or curing process. Two holes (2 mm diameter, not shown) at the centroid of opposing faces on the petri dish were created by melting the plastic mold. Referring to FIG. 3, a P400SR filament 102 spanning the length of the wooden setup 100 was inserted through these holes and then restrained using binder clips 104 that prevented the bending of the filament 102 by providing tension. Specimen preparation was then conducted the same as for the control samples. This method proved successful when testing mono channel architectures but proved to be inefficient with the infusion of more intricate architectures such as diagonal or diamond patterns. For that reason, the outlet method was then developed and proved successful to be implemented in any type of architecture, including the mono channels.

The Outlet method eliminated the need for binder clips to provide tension to the filament. Instead, prior to inserting the pliant filament into the mold, the filament was secured down, and tension was applied only on one end. A heat gun was used to warm up the filament until it naturally straightened out. The straightened filament was cut to span the length of the petri dish and two additional filament pieces (≈4 mm) were cut and glued (with water soluble glue) onto the end of the straightened filament in the same direction in order to form the outlets (FIGS. 4A-4B). This completed outlet model was then placed in the center of the petri dish and glued down. Specimen preparation was then conducted the same as for the control samples. The model includes sacrificial material 190 that is removed to form an inlet 192, an outlet 194, and a passage 196 connecting inlet 192 and outlet 194 for adding the phase change material.

### Engineering Channel Architectures

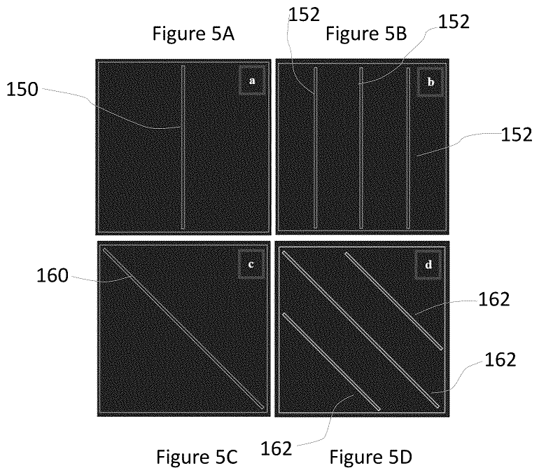

After the most effective channel incorporation method had been determined, the outlet method approach was used with varying architecture models due to its compatibility with complex integrated architectures. The first tests were done on the parallel mono channel defect with different channel architectures: Mono Parallel channel 150 (FIG. 5A), Triple Parallel channels 152 (FIG. 5B), Mono Diagonal channel 160 (FIG. 5C), and Triple Diagonal channels 162 (FIG. 5D). The next test consisted of tripling the defective volume by incorporating the three channels 152 (FIG. 5B) into the set up instead of one channel 150 (FIG. 5A). The three channels 152 were parallel and placed equidistant from one another to maintain uniformity for mechanical and thermal tests.

After the parallel channels had been created and tested, diagonal patterns were modeled (FIGS. 5C and 5D). Similar to the parallel channels, the first test conducted was a mono channel 160 diagonal model (≈124 mm) (FIG. 5C). The diagonal pattern architecture was measured at a 45 degrees angle from the top of the petri dish and the channels 162 in the triple diagonal model (FIG. 5D) were placed 10 mm away from one another and the two outside filament segments spanned 110 mm.

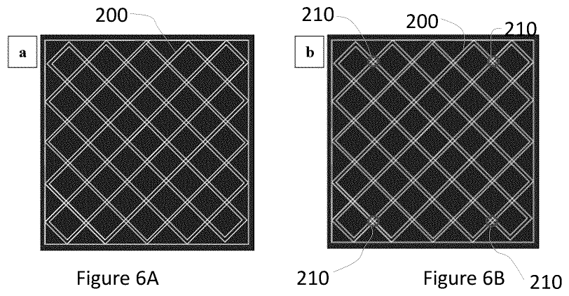

The primary goal with different channel architecture creations was to find the most effective, uniformly distributed pattern in which the PCM could evenly spread through. Thus, the last test done consisted of the most complex architecture: the diamond pattern. This pattern was created by of gluing 10 mm long filaments in a diamond pattern (FIG. 6A) with a location of outlets 210 on a diamond architecture 200.

The outlets 210 were then attached on the outside four corners to remain within the grips during tensile strength tests and then the whole model was glued down to the petri dish.

### Filament Dissolution

After the control samples and varying architecture samples were formed, cement paste was carefully poured into the molds and sprayed excessively with water to prevent the concrete from drying out. A plastic cover was then placed on top to contain the moisture content in the sample. After being cured for 24 hours, the plastic petri dish was removed and the sample was placed into synthesized pore solution for seven days, to allow for complete dissolution of the filament inside the cementitious sample.

### Mechanical Experimental Design

Incorporating vascular architectures into the cementitious slabs creates voids which are a form of defects that influence the mechanical performance. To examine the mechanical properties of the vascular slabs and evaluate the effect of incorporating channels on their tensile strength, a direct tensile test setup was developed.

### Preparation of Tensile Samples

After 14 days of curing at room temperature (~25 °C), samples were prepared for the tensile test. To eliminate the potential slippage of sample through the grips during the tensile test, four ½ in×3 in wood pieces were cut using electric saw and were subsequently glued to each cement paste slab in a way that they can cover the outermost half inch sides of the sample on both sides. Wood glue was used for this purpose.

### Experimental Set Up

A Universal Testing Machine (UTM) was used to evaluate the tensile properties of the cementitious slabs at room temperature (~25 °C) under direct uniaxial tensile stress. A direct tensile test was conducted on samples to capture load against extension under tension. A 5 kN load cell was used to apply load at a rate of 2 mm/min until sample breaks. The load and the corresponding extension of the crosshead as the elongation of sample were recorded every 0.1 sec.

### Thermal Experimental Design

### Experimental Setup

Infrared thermography (IRT) is a non-destructive technique that allows the user to measure and map the infrared radiation ( [symbol] =780 nm~1 mm, f=300 GHz to 400 THz) reflected from a surface. IRT has been widely used for the detection of inhomogeneous features in concrete, an it is widely regarded as a versatile non-destructive testing (NDT) method for indoor laboratory experiments and structural health monitoring of infrastructure (i.e., bridge decks, building panels, concrete slabs, etc. An infrared (IR) camera FLIR A325, equipped with an uncooled Vanadium Oxide microbolometer detector that produces 320×240 pixel images, was used. To capture images, ResearchIR Software® was utilized; the settings can be configured, using the graphical user interface, to record a specific number of frames per second (i.e. 4-60 frames per second) over a pre-determined time period. The IR camera was connected to a data-logging computer using a 1000 Mbps Ethernet connection to allow uninterrupted video recording.

Moreover, the software can be used to data characterization; in addition to extraction of individual images, spatial pixel data, temporal graph, and histogram chart can be exported for each frame with high accuracy.

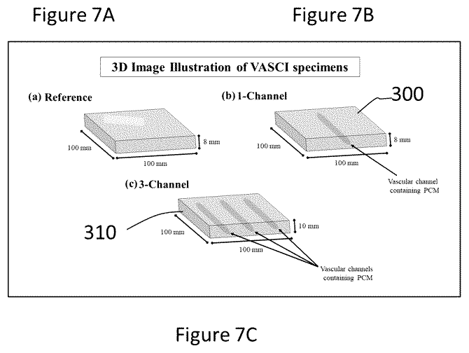

FIGS. 7A-7C show the illustration and dimensions of the VASCI specimens used in this study (i.e., Reference specimen (FIG. 7A), 1-channel specimen 300 (FIG. 7B), and a 3-channel specimen 310 (FIG. 7C)). It was concluded that the emissivity of surfaces that are being used for IRT investigation has a huge impact on the accuracy of data collection. The emissivity depends on several factors that can affect the accuracy of the experiment, such as temperature, surface roughness, wavelength, and viewing angle. ‘Reference’ cement paste, ‘1-channel’ cement paste, and ‘3-channel’ cement paste specimens preparation was performed with proper care, and smooth top surface was ensured. After the curing and dissolution steps were completed to create the vascular channels, liquid PCM-18 was injected into the vascular network of ‘1-channel’ and ‘3-channel’ specimens 300, 310 and the channels were sealed using fast-setting adhesive glue (i.e., superglue). It should be noted that the ‘3-channel’ specimen had three times more volume of PCM in comparison to the ‘1-channel’ specimen. Afterward, the specimens were spray painted with white matte color to allow maximum emissivity (ε≈1.0) during the IRT investigation. The specimens were exposed to ambient room temperature (T≈25 °C) conditions for an additional three hours to allow the paint to dry. Later, each VASCI specimen was placed in a thermally insulated box (i.e., styrofoam box, interior spray painted with black color to allow maximum absorption of reflected waves and reduce noise on images captured by the IR camera). The styrofoam box with the specimen was placed in an environmental (EV) chamber for an additional 24 hours at 22 °C to allow each of the VASCI specimens to reach thermal equilibrium before the initiation of temperature change. Before the IRT investigation commenced, the experimental setup was covered with black fabric for noise reduction during video recording. Owing to the fact that infrared radiation from the IR camera tends to bounce around the chamber, it was critical to minimize and absorb the reflected infrared waves from the specimen surface. As black surfaces have zero emissivity (i.e., total absorption), the setup was necessary.

### Channel Dissolution

After seven days of curing and dissolution in pore solution, the concrete slab samples were removed and checked for filament remnants. With tests completed using the Binder Clip Method as disclosed above, the outlets were in the same plane and thus, dissolution was checked by inserting a copper wire (not shown) through the channel void. If any excess filament was present, the copper wire pushed it out the other end. A challenge using the Outlet Method was the inconvenience of testing dissolution. As a result of the outlets being in different parallel planes, this method forced the reliance on complete dissolution before PCM incorporation since a wire could not be pushed out the other end.

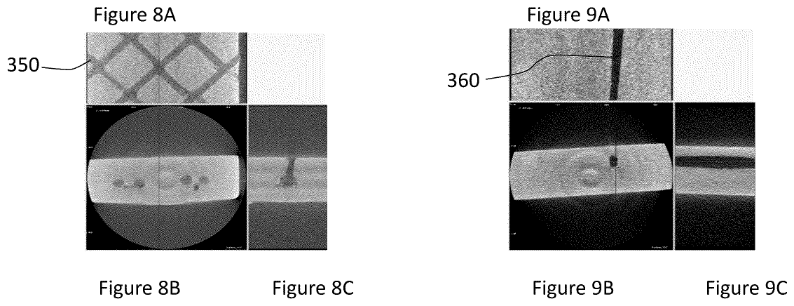

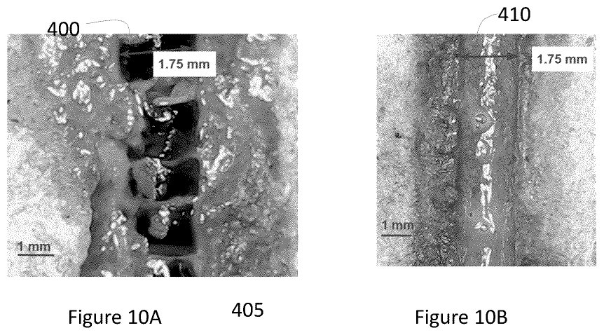

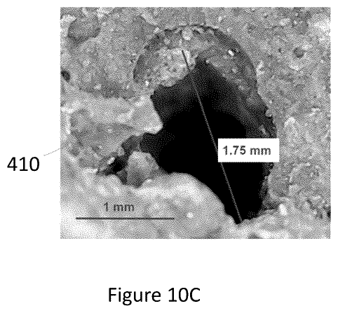

To theoretically check if channels had been created, X-ray tomography was utilized to clearly gauge dissolution within a sample. FIGS. 8A-C and 9A-C demonstrate the orthographic views of samples in which the outlet method was used. FIGS. 8A-8C show a diamond pattern 350, while FIGS. 9A-9C show a monofilament 360. To experimentally confirm this data, the samples were broken in half to examine accuracy of void creation and filament dissolution. An issue that arose after the sample breaking tests was finding out that the filament hadn't completely removed, and tiny segments 400 remained in the channels 405 that the X-ray was unable to detect. (FIG. 10A).

For samples made after, dissolution was confirmed through water analysis. A syringe filled with water was inserted through one outlet opening and it was concluded that complete dissolution has been achieved if water came out the other end. This analysis method proved more efficient to accurately determine dissolution. FIGS. 10B and 10C represent a sample that was broken in which the filament in the channel 410 had been completely removed.

Ultimate tensile strength at failure was calculated by dividing the maximum load by the effective cross-section area (i.e. the area of the samples between the grips). Strain was manually calculated by dividing the extension of the crosshead by the initial gauge length. Modulus of elasticity was calculated using the slope of the Stress-Strain curves. Results for samples with different channel quantity and orientation were then compared to control sample, which is a slab of the same size with no incorporated channel.

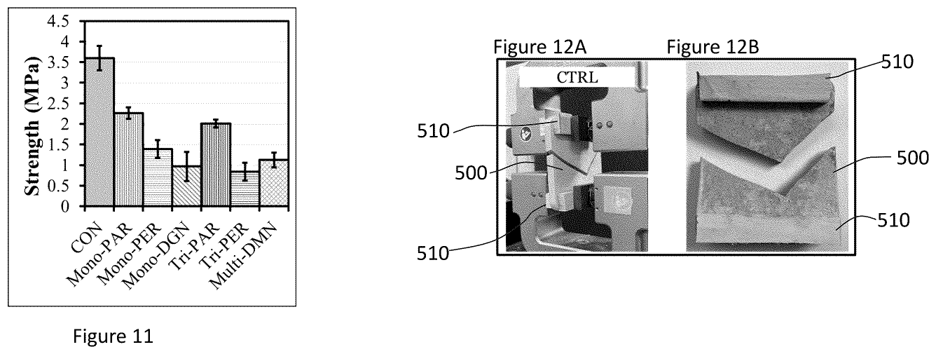

FIG. 11 and Table 4 tabulate the average tensile strength for samples with various vascular architectures. Control samples had the highest tensile strength with an average of 3.6 MPa. In samples with incorporated vascular channels, Parallel samples showed the highest tensile strength with Parallel (PAR) mono- and Tri-channel having an average strength of 2.26 and 2.01 MPa, respectively. The Perpendicular (PER) Tri-channel sample showed the lowest tensile strength (0.84 MPa). Results indicate that orientation and volume of channels affect the tensile strength. However, the effect of channel volume on tensile strength is not linear.

By calculating the volume of channel in various samples to determine the defect volume percentage, it is shown that although diamond samples had the highest defect volume (13.97%), they have a higher tensile strength compared to Perpendicular Tri-channel and Diagonal Mono-channel samples. According to channel volume calculations, diamond samples have approx. 2000% more defect volume compared to Diagonal Mono-channel, while maintaining a higher tensile strength (~16%). This observation indicates that increasing the defect does not necessarily result in weaker vascular samples, and emphasizes on the important role that vascular architectures play on the mechanical performance.

TABLE 4
Strength and Defective Volume of different sample architectures

| | Avg | Standard Deviation | Defective Volume |
|---|---|---|---|
| Sample | (MPa) | (MPa) | (%) |
| CONTROL | 3.60 | 0.30 | 0.00 |
| Mono- PAR | 2.26 | 0.14 | 0.47 |
| Tri- PAR | 2.01 | 0.09 | 2.13 |
| Mono- PER | 1.39 | 0.22 | 0.47 |
| Tri- PER | 0.84 | 0.22 | 2.13 |
| Mono- DGN | 0.97 | 0.36 | 0.66 |
| Multi- DMN | 1.13 | 0.18 | 13.97 |

### Fracture Patterns

To study the fracture patterns of samples with various number and orientation of channels, images were captured from the fractured surface and cross-sections after the tensile tests. As can be observed in FIGS. 12A and 12B, control samples 500 broke within the gauge length between the two wood pieces 510 indicating a brittle tensile failure. However, the fracture patterns in different control replicates were not similar.

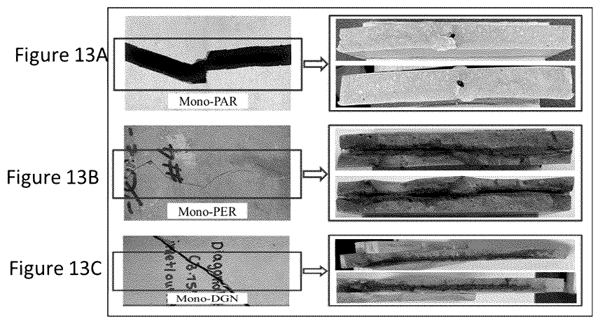

Unlike the control samples, fracture surface in Mono-Perpendicular and Mono-Diagonal (DGN) samples followed a consistent pattern along the channel inclusion direction for a Mono channel fracture patterns: (a) straight channel broken in the parallel direction (FIG. 13A), (b) straight channel broken in the perpendicular direction (FIG. 13B), and (c) diagonal channel broken in the parallel direction (FIG. 13C). This observation agrees with the low tensile strength measured for Mono-Perpendicular and Mono-DGN samples since crack propagation along the defect requires less energy. On the other hand, in Mono-Parallel, fracture pattern was perpendicular to the orientation of the defect which accounts for a higher energy required for crack propagation and hence, resulting in a higher tensile strength.

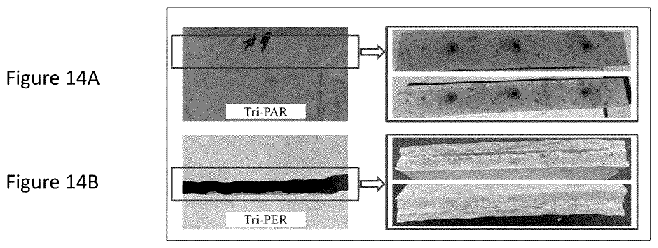

FIGS. 14A and 14B show a top plan view and interior broken sections of a Tri-PAR configuration and a Tri-PER configuration, respectively.

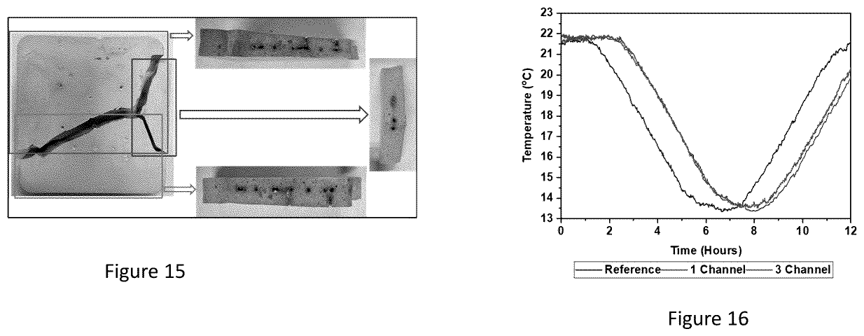

In FIG. 15 it can be observed that the multi-diamond (DMN) sample has a complex fracture pattern which causes energy dissipation. This can be the reason for the multi-DMN sample possessing a higher tensile strength although it has higher volume of defect compared to Tri-Per and Mono-DGN samples. Stress-displacement results also confirm this observation by showing higher displacement until total rupture in multi-DMN samples, compared to others.

### Thermal Behavior

Heat Transfer within the concrete specimen is dictated by conduction theory, and the material properties dictates the thermal properties. In other words, Fourier's heat transfer differential equation (Equation 1) can be used to model the heat transfer:

ρc∂T/∂t=Q′+∇·(k∇T) Equation 1
where,
   ρ=density of the material (kg/m³)
   c=specific heat capacity of the material at constant pressure (J/kg·K)
   k=thermal conductivity of the material (W/m·K)
   T=absolute temperature (K)
   Q′=internal heat generation rate (W/m³)
   t=time (seconds)

The energy exchange between the surface of the concrete specimen and the surrounding environment can be expressed by the following equation:

nkk∇T=q Equation 2
where, q is the rate of energy transfer at the surface of the concrete specimen. The rate of energy transfer depends on concrete surface specimen, ambient environment, and thermal radiations from the surface to the environment.

q=qₛ+q_{con}+qᵣ Equation 3

qₛ=αI Equation 4

q_{conc}=h_{c}(T_{c}−Tₐ) Equation 5

h_{c}=3.83v+C Equation 6

qᵣ=ϵ(σT_{α}⁴−σT_{c}⁴) Equation 7
where,
qₛ=thermal energy due to radiation received by the concrete surface from the heat source.
α=absorption coefficient of concrete surface
I=total radiation flux on the surface (W/m²)
q_{con}=Newton's law of cooling, heat transfer (loss or gain) through convection between the concrete surface and the surrounding atmosphere due to temperature difference.
h_{c}=convective heat transfer coefficient (W/m²·K)
T_{c}=concrete surface temperature
Tₐ=surface surrounding air temperature
qᵣ=Heat loss from the concrete specimen surrounding environment through long wavelength radiation.
σ=Stefan-Boltzmann constant=5.677×10-8 W/(m²·K⁴)
ϵ=emissivity of the material

FIG. 16 shows the temporal plot of VASCI specimens used in the IRT investigation. Initial interpretation show that the average temperature of all specimens remained consistent 21.5 °C to 22 °C for ≈1.25 hours. Consequently, with the decrease of temperature in the EV chamber, the Reference specimen demonstrated similar trend in temperature decrease. On the contrary, average temperature of 1-Channel and 3-Channel specimens remained consistent between 21.5 °C to 22 °C for additional ≈1 hour; both VASCI specimens demonstrated higher thermal inertia in comparison to Reference specimen. This observation can be attributed toward the inclusion of PCM in the vascular channels. Furthermore, the 1-Channel and 3-Channel specimens maintained a consistent 1.5-2 °C temperature difference in comparison to the Reference during the cooling stage of this experiment; similar observations were observed during the heating stage of the experiment as well.

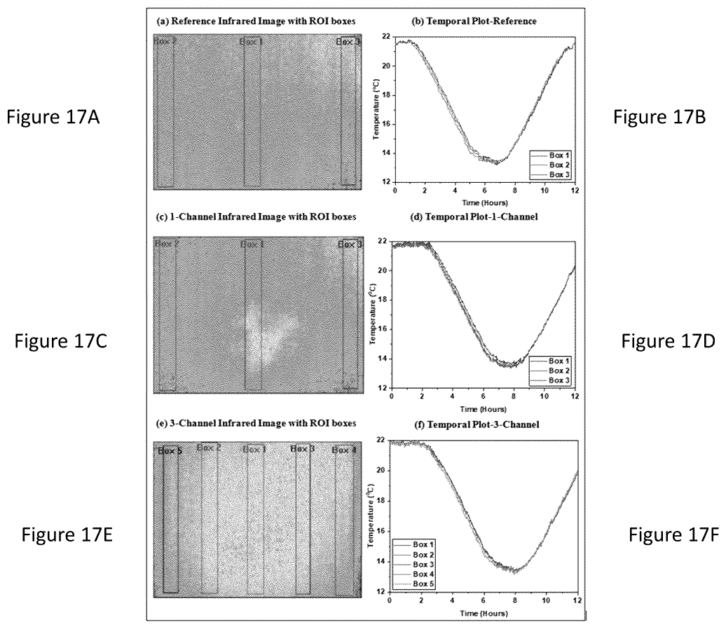

To further discretize the temperature difference between the mid-sections and peripheral regions of all the VASCI specimens, several regions of interest (ROIs) were plotted on the infrared images and subsequent temporal plots were generated using the data. FIGS. 17A, 17C, 17E each shows the infrared images and ROIs of Reference, 1-Channel, and 3-Channel VASCI specimens, respectively, while FIGS. 17B, 17D, 17F each shows the temporal images of ROIs plotted on the infrared images of Reference, 1-Channel, and 3-Channel VASCI specimens, respectively. Two additional ROIs were plotted for the 3-Channel VASCI specimen (i.e., Box 2 and Box 3); as the 3-Channel specimen has two more vascular channels, it was necessary to identify the thermal response around those regions. Data analyses of temporal plots of ROIs drawn on Reference, 1-Channel, and 3-Channel VASCI specimens indicate that the temperature differences between the respective ROIs are minimal. In addition, the ROIs on 1-Channel, and 3-Channel VASCI specimens demonstrated heightened thermal inertia and maintained 1.5-2 °C temperature difference in comparison to Reference specimen ROIs during the cooling and heating stages of the IRT investigation.

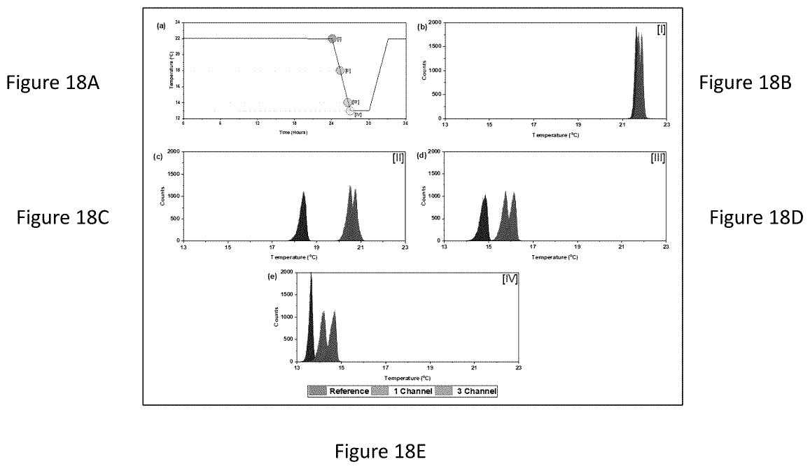

FIG. 18A shows a temperature profile of the infrared thermograph investigation of Reference, 1-Channel, and 3-Channel VASCI specimens. FIGS. 18B-18E is a sequence of images showing the histogram plots of the VASCI specimens at four temperature stages: [I] 22 °C, [II] 18 °C, [III] 14 °C, [IV] 13 °C. The histogram plots data were generated by extracting data by utilizing the Research IR software; ROI was plotted around the specimen boundaries using the graphical user interface, and csv. files from each frame were extracted manually for each respective VASCI specimen for several frames. For instance, at [I] 22 °C, FIG. 18B shows that all the specimens reached thermal equilibrium with the EV chamber after 24 hours; data suggests that the temperature across the specimens are consistent at 22 °C. FIG. 18C shows the temperature distribution across the specimens at [II] 18 °C; as the PCM-18 onset temperature for phase transition was ~18 °C, both 1-Channel and 3-Channel VASCI specimens exhibited positive temperature difference of 1.5-2 °C at that stage. Similarly, for stages [III] and [IV], it was also observed that the histogram charts of both 1-Channel and 3-Channel specimens maintained a positive temperature difference until the EV chamber reached 13 °C. Furthermore, the histogram plot of the 3-Channel VASCI specimen maintained the highest temperature difference in comparison to the Reference, followed by the 1-Channel specimen. This observation is concurrent with the fact that the 3-Channel VASCI specimen had three times more volume of PCM liquid incorporated into the channels, compared to the 1-Channel VASCI specimen. Using these observations, PCM inclusion into the vascular channels of the cement paste specimens increased thermal inertia by a certain degree. More studies need to be conducted to further elucidate this effect in a numerical manner.

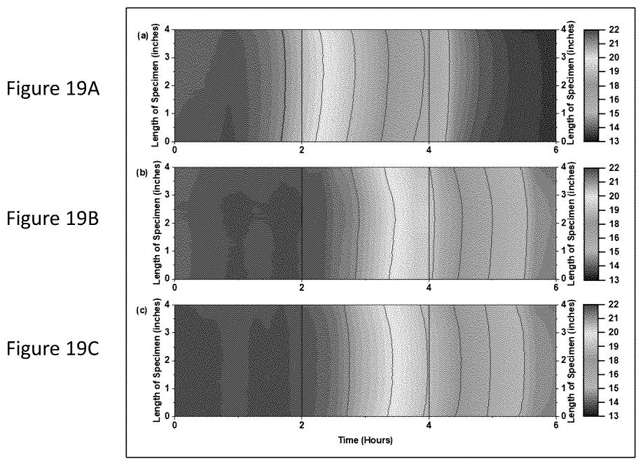

FIGS. 19A-19C show the thermal contour profiles of the Reference, 1-Channel, and 3-Channel VASCI specimens, respectively. Using the data collected from the IR images, the temperature from each frame was averaged across the length of the specimen. Afterward, the temperature profiles from each frame were plotted against time to generate the contour plot, specifically, for the cooling stage of the experiment. FIG. 19A shows the contour plot of the Reference specimen, which acts as a baseline for comparison; FIGS. 19B-19C show the contour plot of 1-Channel and 3-Channel VASCI specimens. Overall, the contour plots show good agreement with the observation interpreted on the temporal plots (i.e., FIG. 16 and FIG. 17A-17F). The inclusion of PCM led to the enhancement of the thermal inertia of the 1-Channel and 3-Channel VASCI specimens, which allowed the cement paste specimens to maintain a consistent 1.5-2 °C positive temperature difference in comparison to the environment temperature.

Civil infrastructure is also exposed to variety of dynamic stimuli like biological cases such as thermal, moisture, mechanical, and light loadings; and nature-inspired vascular concepts can be used to create next-generation infrastructure materials, VASCI. VASCI can autonomously respond to accommodate environmental conditions and service-life needs for better performance and/or multi-functionalities.

Here we provide passive self-thermal responsive functionality to engineer thermal-VASCI that can be used in civil infrastructure for thermoregulation and thermal energy management strategies. Thermal-VASCI can be used to create infrastructure components (such as panels, prefabricated elements, tiles, walls, floors, and ceiling) and then used in: buildings for thermoregulation (for lowering energy demands in buildings which are responsible for ~40% of the world's energy usage), infrastructure snow-melting/deicing applications, or infrastructure exposed to thermal loading to reduce thermal cracking.

To engineer thermal-VASCI, the present invention provides methods to create vascular channels at multi-scale lengths in cementitious materials to create VASCI and (2) incorporate passive thermal self-responsive phase change materials (PCM) fluid in cementitious matrix.

The fundamental knowledge of integrating vascular concept in cementitious materials provided here can then be used to engineer various types of VASCI for different needs as broader scientific impact. VASCI can be engineered with tuned vascular network structure and tailored self-responsive vascular fluid for applications such as seismic exposure (pressure-responsive), indoor air moisture regulation (moisture-responsive), self-healing (damage-responsive), indoor light control (light-responsive), damage diagnosis (neural-responsive), or stormwater management (fluidic-responsive).

It will be further understood that various changes in the details, materials, and arrangements of the parts which have been described and illustrated in order to explain the nature of this invention may be made by those skilled in the art without departing from the scope of the invention as expressed in the following claims.

I claim:

1. A method of forming a thermal vascular self-responsive composite comprising the steps of:
(a) providing a cementitious composite material;
(b) inserting a sacrificial filament into the material;
(c) removing the filament, forming a channel; and
(d) inserting a phase change material into the channel.

2. The method according to claim 1, wherein the filament comprises a polymer filament soluble in a hydroxide solution.

3. The method according to claim 1, comprising the step of, after step (b) and before step c, the step of curing the cementitious composite material.

4. The method according to claim 1, wherein step (c) comprises the step of dissolving the filament in a pore solution.

5. The method according to claim 1, wherein step (c) comprises the step of forming architected channels.

6. The method according to claim 5, wherein step (c) comprises forming a plurality of parallel architected channels.

7. The method according to claim 5, wherein step (c) comprises forming a plurality of intersecting channels.

8. The method according to claim 7, wherein the intersecting channels form a diamond pattern.

9. The method according to claim 1, wherein the phase change material comprises a salt-based material.

10. The method according to claim 1, wherein the phase change material comprises a paraffin-based material.

11. The method according to claim 1, wherein the insertion of the phase change material into the channel increases the thermal inertia of the cementitious composite material.

12. The method according claim 11, wherein the cementitious composite material is exposed to an environmental temperature and wherein the increase in the thermal inertia maintains the cementitious composite material at a temperature about 1.5 °C different from the environmental temperature.

13. The method according to claim 1, wherein the channel has a diameter of about 1.75 mm.
